(19) United States
(12) Patent Application Publication
(10) Pub. No.: US 2013/0238199 A1
(43) Pub. Date: Sep. 12, 2013

(54) ALCOHOL DETECTION SYSTEM FOR VEHICLE DRIVER TESTING

(71) Applicants: Nolann George Williams, Fallbrook, CA (US); Ronald Louis Williams, Fallbrook, CA (US)

(72) Inventors: Nolann George Williams, Fallbrook, CA (US); Ronald Louis Williams, Fallbrook, CA (US)

(73) Assignee: TRANSBIOTEC, INC., Seal Beach, CA (US)

(21) Appl. No.: 13/417,595

(22) Filed: Mar. 12, 2012

(51) Int. Cl. G06F 7/00

(52) U.S. Cl. 701/49

(57) ABSTRACT

An alcohol detection system incorporates a resistive touch sensor mountable in a vehicle for determining presence of alcohol based on changed skin resistance. An ignition interlock is provided in the vehicle and a microcontroller is connected to and receives data from the touch sensor and provides a signal to open the interlock to disable the vehicle upon receipt of data from the touch sensor exceeding a predetermined value. The system also employs operator identification and vehicle location systems with a data logger allowing the microcontroller to store data on test results, operator identification and vehicle location. Additionally, the system may employ a cellular communication system to allow reporting of the data to a remote location.

### BACKGROUND INFORMATION

1. Field

Embodiments of the disclosure relate generally to the field of alcohol detection systems and more particularly to a skin resistive sensor detection system incorporating ignition interlock capability, reporting, operator identification and vehicle location systems.

2. Background

The detection of alcohol impairment has long been a significant issue for operators of motor vehicles. Accidents and fatalities due to driving while under the influence of alcohol continue to increase and even with strong enforcement of vehicle codes imposing significant fines and sentencing of offenders, passive deterrence remains ineffective for reducing the incidences of driving while impaired.

For operators of commercial vehicles the potential liabilities associated with drivers operating vehicles while impaired by alcohol have significant economic impact. Consequently, real time testing of vehicle operators and the capability to identify and confirm the tested individual to assure that the driver of the vehicle is the individual taking the test is desirable.

Prior art systems for alcohol detection/testing in vehicular applications typically employ breath or vehicle interior gas detection for alcohol vapor. Systems for alternative detection forms have been costly and most systems are complex and/or excessively expensive or do not provide desired reliability in detection.

It is therefore desirable to provide an alcohol detection system for vehicle driver testing which employs reduced complexity while providing precise detection capability. It is further desirable for the system to provide identification of the tested driver to assure that the tested individual is the vehicle operator. It is also desirable for the system to provide affirmative vehicle disablement or identification with automated communication of status.

### SUMMARY

Embodiments disclosed herein provide an alcohol detection system which incorporates a resistive touch sensor mountable in a vehicle with a vapor sensor for determining presence of alcohol based on changed resistance in a predetermined interval. An ignition interlock is provided in the vehicle and a microcontroller is connected to and receives data from the touch sensor and provides a signal to open the interlock to disable the vehicle upon receipt of data from the touch sensor exceeding a predetermined value, or alternatively with the interlock initially open to prevent operation of the vehicle, closing the interlock to allow operation of the vehicle upon passing of the test.

In certain embodiments, the system also employs operator identification and vehicle location systems with a data logger allowing the microcontroller to store data on test results, operator identification and vehicle location. Additionally, the system may employ a cellular communication system to allow reporting of the data to a remote location.

The embodiments disclosed provide a method for disabling a vehicle with an alcohol detection system including a resistive touch sensor where when the system is powered on a startup time is recorded on a data logger by a microcontroller. An operator indicator to is then activated to notify an operator that a test is required at a predetermined time programmed into the microcontroller. The touch sensor data is then read when the operator places a finger on the touch sensor and a second operator indicator is activated signifying that the test is in process. The elements of an identity verification system and location and anti-theft system are also activated. Data is then collected with the microcontroller from the touch sensor, identity verification system and the location and antitheft system. If the operator removes his finger before testing is complete, the microcontroller returns to the step of activating the operator indicator a requiring the operator to restart the test, otherwise, the second operator indicator is extinguished notifying the operator that the test is complete. Time/date information and data from the touch sensor, identity verification system and location and anti-theft system are then stored in a data logger. If the test result shows impairment, operator is notified with a third operator indicator to show test failure and the ignition interlock is opened preventing operation of the vehicle. If no impairment is shown by the test, the microcontroller remains inactive for a predetermined period until additional testing is required.

The features, functions, and advantages that have been discussed can be achieved independently in various embodiments of the present disclosure or may be combined in yet other embodiments further details of which can be seen with reference to the following description and drawings.

### BRIEF DESCRIPTION OF THE DRAWINGS

FIG. 1A is pictorial view of an exemplary sensor subassembly to be employed with embodiments of the invention;

FIG. 1B is a partial side section view of details of the sensor subassembly of FIG. 1A;

FIG. 2 is a block diagram of system elements for an embodiment;

FIG. 3 is a flow chart of system operation; and,

FIG. 4 is a schematic of example electrical circuit elements of the embodiment.

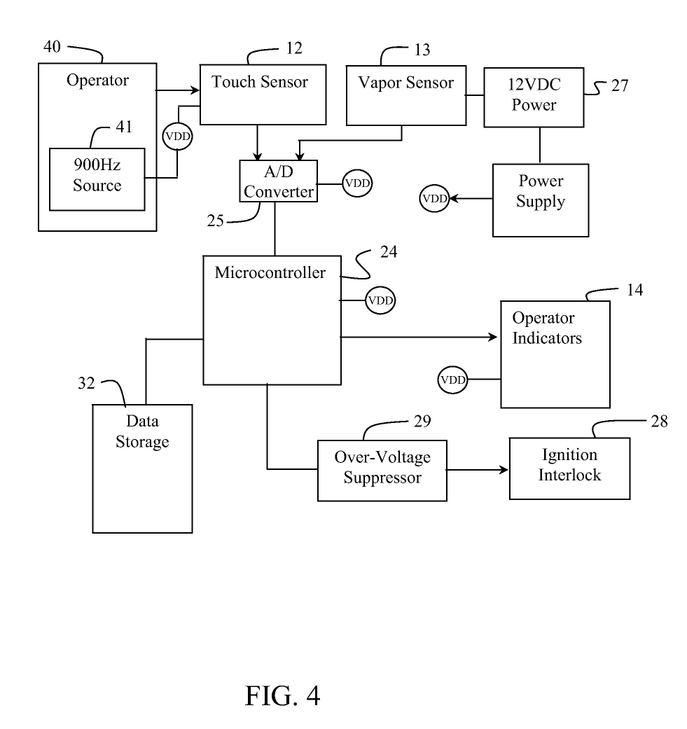

### DETAILED DESCRIPTION

Embodiments disclosed herein provide an alcohol detection system incorporating a hand held or mountable detector case with a resistive touch sensor and vapor sensor to measure a finger of a test subject such as a vehicle operator, a microprocessor control system with data recording and communications capability, a vehicle systems interface, an identity verification system and a location confirmation system.

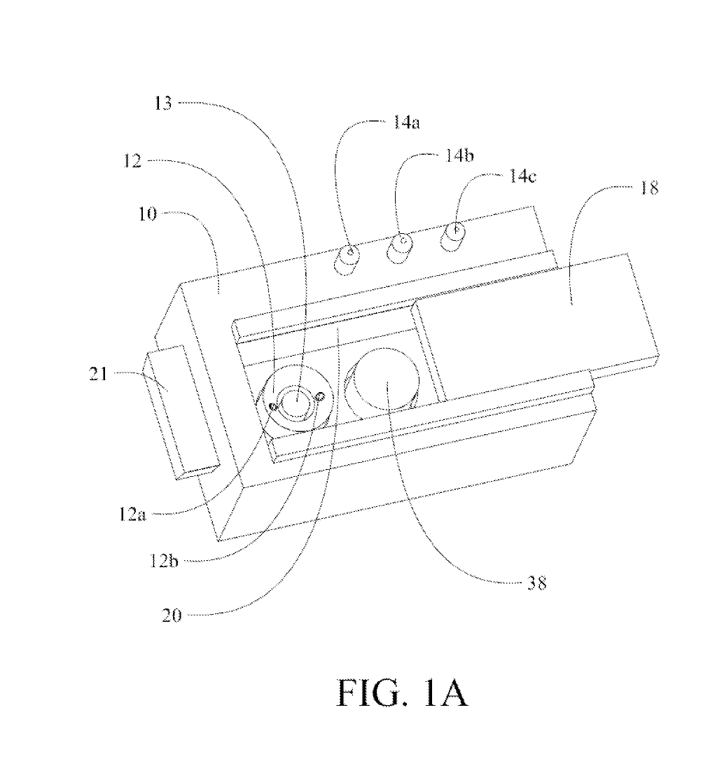

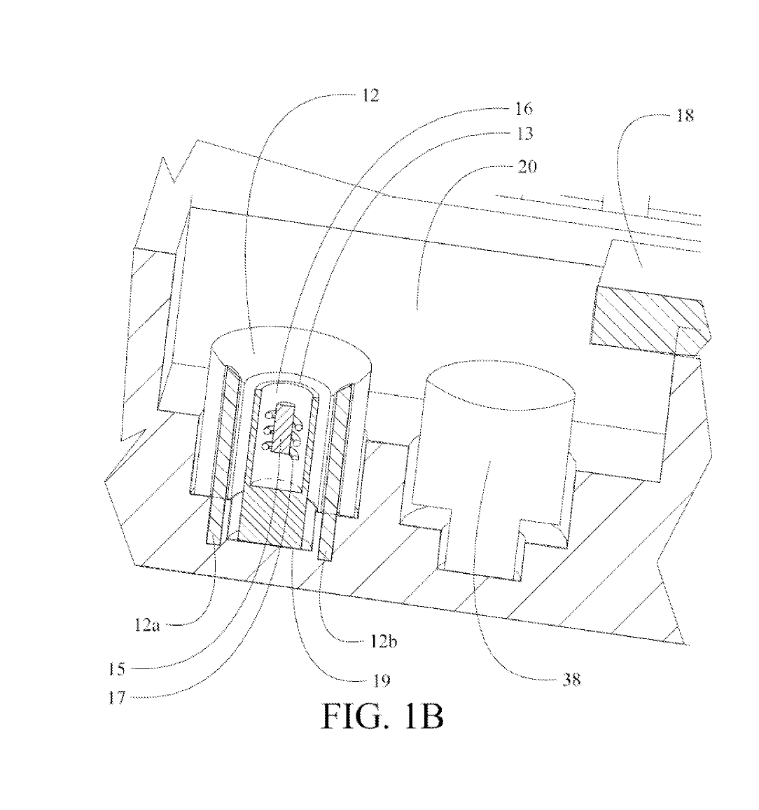

Referring to FIGS. 1A and 1B, a detector case 10 houses a resistive touch sensor, generally designated as element 12, and an ethanol vapor sensor 13. The touch sensor incorporates a plastic housing with two wire probes 12a and 12b (best seen in FIG. 1B) which are exposed at a surface around the cavity 16 surrounding the vapor sensor 13 as a gas sensing volume. The touch sensor measures skin resistance and only triggers for sampling the vapor sensor if the resistance shown is between about 100 kilohms and 1.5 megohms. A lower resistance and the vapor sensor is inoperative thus a conductive covering on the finger of the test subject such as aluminum foil cannot be used to fool the detector. A higher resistance equally renders the touch sensor inoperative so a rubber glove covering the finger of the test subject also cannot be used to fool the detector.

For an example embodiment, the vapor sensor is a tin oxide-Taguchi type sensor. Vapor sensors suitable for initial embodiments have been identified as available from Figaro Engineering Inc. 1-5-11 Senba-nishi Mino, Osaka 562-8505 JAPAN. The Taguchi sensor incorporates a tin oxide coated ceramic element 15 and a heater screen printed on its surface, represented by helix 17. The vapor sensor is suspended inside a standard TO-5 package 19 with a stainless steel screen over the top (not shown in the drawings for clarity) to provide a sampling volume shown as cavity 16. The tin oxide is selective to the gas it is most sensitive to based on its temperature. The tin oxide sensor changes its resistance as a function of ethanol gas concentration. A change in resistance greater than ˜1 k+ ohms to indicates enough alcohol in body to indicate operator impaired performance of vehicle operation.

Tin oxide vapor sensors are temperature dependent for maximizing sensitivity to various detectable vapors. At about 440 C detection of ethanol is optimum. The most common Taguchi sensor application is in refineries where the sensor is heated to about 540 C and is most sensitive to hydrogen sulfide. The heater element is sized differently to produce a range of sensors with most selective response to a specific gas. If the tin oxide sensor is at any other temperature than its set point it is less sensitive to ethanol and more sensitive to other gases. Since the ambient temperature affects the case temperature and this case temperature affects the sensor element, the most sensitive reading is only when the sensor is at its set point which has been calibrated at an ambient temperature of approximately 20 C. To compensate for ambient temperature differential, at typical ambient temperature variation ranges, the vapor sensor cannot just measure resistance as a function of ethanol vapor concentration since the variation of tin oxide resistance due to ambient temperature variation is greater than the variation produced by a normal and an excessive alcohol value. For this reason the detector for the embodiments disclosed triggers on an initial and second subsequent resistance reading to obtain a difference measurement after a sufficient predetermined time period for accumulation of gas in the sampling volume. For the embodiment disclosed herein, a resistance value is recorded as soon as the finger is first presented to the touch sensor, and then again after 6 seconds and uses the difference between the two readings to determine acceptance/rejection as will be described in greater detail subsequently.

Operator indicators 14 such as light emitting diodes (LEDs) 14a, 14b and 14c, the operation of which will be described in greater detail subsequently, are mounted in the detector case for communication of status and operational requirements of the system. In alternative embodiments, audible signaling may be used as a substitute for or in conjunction with the visual indicators. For the embodiment shown, the touch sensor 12 is mounted in a chamber 20 in the case allowing a slideable cover 18 to be placed over the touch sensor when not in use. Wiring for interconnection of the detector case to vehicle system is accomplished through plug 21 (actual wiring is omitted for clarity in the drawings).

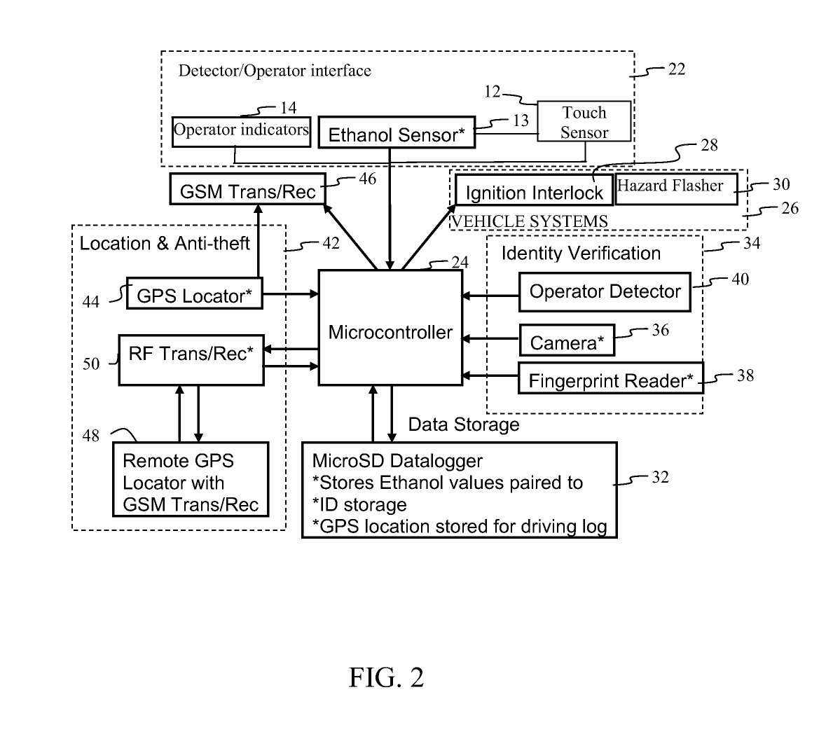

As shown in FIG. 2, the touch sensor 12 and operator indicators 14 (LEDs 14a, 14b and 14c of FIG. 1) which constitute the operator/detector interface 22 are connected to a microcontroller 24 such as a model PIC16F870 (or 16F886)-/SO available from Microchip Technology Inc.

The microcontroller 24 receives signals from the touch sensor 12 and vapor sensor 13 and provides timing and control output to the operator indicators 14. The microcontroller 24 is also interconnected to applicable vehicle systems 26 including an ignition interlock 28 and, in certain embodiments, emergency flasher indicators 30. While shown in the embodiment in the drawings as a separate detector case 10, the operator/detector interface 22 may be integrated into the vehicle instrument panel or console. For the tin oxide Taguchi type sensor, the vapor sensor 13 is connected directly to the +12 V power system 27 of the vehicle to allow proper power and to maintain an “on” condition since the Taguchi type sensor requires a warm-up time for proper operation.

The microcontroller 24 receives data through an analog to digital converter 25 from the touch sensor 12 and vapor sensor 13 and provides output to the operator indicators 14 to require the initiation of a test and indicate test pass or fail. The microcontroller is programmed to test change in tin oxide vapor sensor resistance. When an operator's finger is touched to the touch sensor 12 in the detector case 10, if proper resistance is present across the wires 12a and 12b of the touch sensor, the vapor sensor 13 is activated. An initial resistance reading is taken by the microcontroller immediately upon activation and a second resistance reading is taken after a predetermined time differential. For the embodiment disclosed, the predetermined time differential is 6 seconds. A change in resistance of greater than ˜1 k+ ohms between the initial resistance reading the second resistance reading indicates enough alcohol in body to indicate impaired operator performance with respect to vehicle operation. The operator indicators 14 provide notification to the operator that a test is required, whether the test has been completed properly and whether the test was passed or failed, as will be described in greater detail subsequently.

A data logger 32 is connected to the microcontroller for recording of test times and results. For an example embodiment, the data logger employs MicroSD cards for data storage. The microcontroller 24 and data logger 32 may be contained within the detector case 10 in certain embodiments. However, these elements of the system may be contained in a separate enclosure or integrated in the vehicle panel or consoles.

As previously described, the microcontroller 24 is interconnected to the ignition interlock 28 in the vehicle. Upon failure of a test, the microcontroller disables (or alternatively doe not enable) the ignition of the vehicle preventing the vehicle from being driven. For an example embodiment, the ignition interlock will have a zener diode overvoltage suppression system 29 and series diodes for protecting microcontroller circuitry. Twisted/shielded wiring is employed to further shield the microcontroller from spurious noise radiated from vehicle environment. For an example embodiment, the touch sensor employs an internal relay rated for 1 AMP maximum contact current which is derated to ¼ amp for an automobile application. Most switching circuitry in a vehicle requires 2-4 amps peak current during contact/FET break. The switched interlock line incorporates a point of use relay with standard diodes across the contacts to inhibit contact pitting, a zener diode across the energizing circuit from the touch sensor relay and a series diode from the positive relay line to the point of use relay to suppress EMI and protect the microcontroller. In alternative embodiments, the microcontroller may also engage the vehicle hazard flasher 30 for external identification.

An identity verification system 34 is also interfaced to the microcontroller 24. A still or video camera 36 is employed as a portion of the identity verification system to record an image of the actual vehicle operator. The field of view of the camera may include the face as well as the arm and had of the operator to confirm that operator's hand is, in fact, placed on the touch sensor 12. In addition, or alternatively, a fingerprint reader 38 as shown in FIGS. 1A and 1B may be employed as a portion of the identity verification system. Returning to FIG. 2, an operator detector 40 confirms the presence of the operator in the driver's seat of the vehicle. All data from the identity verification system elements is provided by the microcontroller 24 to the data logger 32 which, for the exemplary embodiment, configures received serial data into an FAT16 data structure and stores it on the MicroSD cards in the data logger 32, also allowing retrieval of stored data to interfaced systems. Data can be stored from any microcontroller interfaced sensor system, such as time, temperature, pictures, or other integrated peripherals. This allows the company operating the vehicle or factory to determine long term calibration issues and sensor calibration times by trending. Additionally the data is useful for company supervision to verify the alcohol detection system was working as designed in case of positive test results. As an added benefit, when using the camera or fingerprint reader elements of the identity verification system, the recorded data will certify that the operator was operating his vehicle according to federal requirements for time behind the wheel.

The fingerprint reader 38 allows biometric recording of operation and testing. In the example embodiment, the fingerprint reader 38 is placed in a location adjacent to the touch sensor 12 as shown in FIGS. 1A and 1B thus requiring two finger operation, with an index finger placed on the touch sensor and the adjacent middle finger placed on the fingerprint reader, further guaranteeing that the operator who is taking the test is the correct person. In alternative embodiments, the alcohol sensor may be integrated into the biometric fingerprint reader.

In an exemplary embodiment, the operator detector 40 employs the operator seated in the seat as an antenna for a ˜900 khz signal generated by a wire coil 41 under the seat. When the alcohol detection system is energized, the wire coil under the sear is energized by a ˜900 khz signal. An electronic filter associated with the touch sensor inputs only accepts the ˜900 khz signal as an initiator for the testing

A location and antitheft system 42 incorporates a global positioning system (GPS) locator 44 interfaced to the microcontroller 24. This allows realtime actual location of the vehicle to be recorded by the microcontroller 24 in the data logger 32. A global system for modular communications (GSM) transmitter receiver 46 may be interfaced to the microcontroller 24 and or GPS locator 44 for transmission of the realtime position to a remote facility for monitoring of vehicle location. The microcontroller may also transmit test results, driver identification or other data through the GSM transmitter/receiver to the remote facility. For the example embodiment, the GSM transmitter/receiver employs the existing cellular phone infrastructure, allowing packets of data to be sent/received from the remote facility or another system integrated to the cellular phone infrastructure. This allows for transmission by the microcontroller of testing results, and other applicable data, such as position, video, sound and other information available from any elements of the system. Further, the GSM transmitter/receiver also allows for system software modification for the microcontroller for upgrades and real-time control of all attached hardware, including managerial overrides to system failures.

The location and antitheft system 42 may also employ a remote GPS locator 48 which is wirelessly interfaced to the microcontroller 24 through an RF transmitter/receiver 50 or other known wireless interface. The RF transmitter/receiver 50 also allows transmission of signals for communications between the microcontroller and any other nearby RF capable systems as an alternative to the GSM transmitter/receiver 46. This allows microcontroller interface for purposes of storage or transmission of data from other nearby RF capable systems even if cellular service may not be available. The remote GPS locator 48 may be a combined small GPS/cell phone transmitter with independent power supply capable of autonomously transmitting information. Modern anti-theft devices allow location of automobiles/trucks. However, such systems have several disadvantages since generally their location is confined to a limited area adjacent to the automotive power supply and as such are easily traceable. The remote GPS locator 48 as an independent system with internal battery power receiving negative feedback, for example via wireless transmission, from other systems and may remain passive (and on low power) until removal of such feedback (such as car theft) or external stimuli such as unauthorized movement, then activate and allow tracking of the automobile to its destination. Placement could easily be literally anywhere in the automobile/truck, battery endurance would be 1-2 years and size approximately the same as a cigarette package.

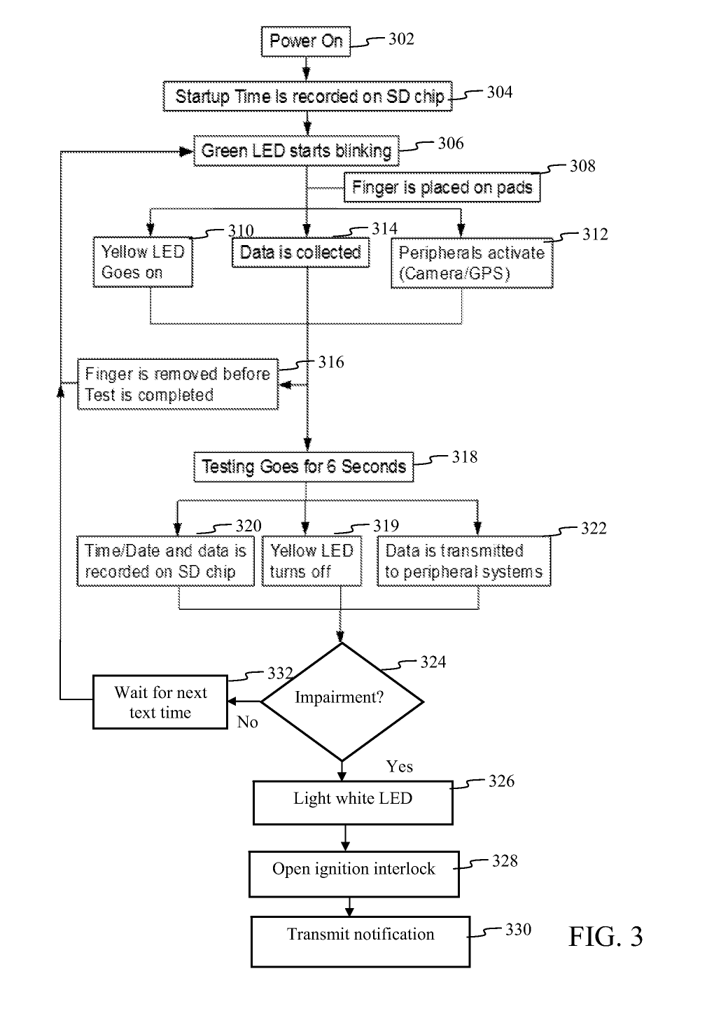

Operation of the alcohol detection system as defined in the described embodiments is shown in FIG. 3. The system is powered on, step 302, and a startup time is recorded on the data logger by the microcontroller 24 step 304. At a predetermined time programmed into the microcontroller 24 (which may be at startup or another time as appropriate), the microcontroller activates the operator indicators 14 to notify the operator that a test is required. For the example embodiment, indicator LED 14a which is a green LED is caused to blink, step 306. The operator then places a finger on the touch sensor 12 and vapor sensor 13 (and on the fingerprint reader 38 if so equipped for operator identification) for data to be read by the microcontroller, step 308. The microcontroller activates a second operator indicator, which for the embodiment shown is LED 14b, a yellow LED, signifying that the test is in process, step 310. The microprocessor 24 activates the elements of the identity verification system 34 and location and anti-theft system 42, step 312. Data is collected by the microcontroller 24 from the vapor sensor 13 with an initial reading and second reading at a predetermined time differential (6 seconds as previously noted for the present embodiment), identity verification system 34 (including fingerprint reader, camera and operator detector) and the location and antitheft system 42 including GPS location, step 314. If the operator removes his finger(s) before testing is complete (before the second reading at the predetermined time differential), step 316, the microprocessor returns to step 306 reactivating the green LED 14a requiring the operator to restart the test. When testing is completed, step 318 (approximately 6 seconds for the disclosed embodiment), the microprocessor extinguishes the yellow LED 14b notifying the operator that the test is complete, step 319. Time/date information and data from the vapor sensor, identity verification system and location and anti-theft system are stored by the microcontroller in the data logger, step 320. The microcontroller may transmit the stored data to a remote facility by employing the GSM Transmitter/receiver 46 or the RF transmitter receiver 50, step 322. If the test result shows impairment, step 324, the microcontroller provides notification to the operator via a third operator indicator, in the embodiment LED 14c which is a red LED, which illuminates to show test failure, step 326. The microcontroller then opens the ignition interlock 28 preventing operation of the vehicle and/or illuminates the vehicle hazard flasher 30, step 328. If programmed to do so, the microcontroller may additionally notify the company or other authorities by transmitting data using the GSM transmitter/receiver with test result data, vehicle location from the GPS locator and driver identification from the identity verification system, step 330.

If no impairment is shown by the test, the microcontroller then remains inactive for a predetermined period until additional testing is required, step 332.

Data transmitted may be employed not only for confirmation of no driver alcohol impairment but may also provide records for federal, state or company driver log requirements. In an example operational scenario, the biometric fingerprint data and/or recorded camera images and rolling retest logic will identify the operator and record his presence behind the wheel. The notification may be by the GSM transmitter receiver as cell phone data or by interrogating the logged data recorded on the internal Mini SD data logger to prove after the fact compliance.

Having now described various embodiments of the disclosure in detail as required by the patent statutes, those skilled in the art will recognize modifications and substitutions to the specific embodiments disclosed herein. Such modifications are within the scope and intent of the present disclosure as defined in the following claims.

What is claimed is:

1. An alcohol detection system comprising:
a resistive vapor sensor mountable in a vehicle for determining presence of alcohol based on changed skin resistance, said vapor sensor triggered for an initial reading by a touch sensor and triggered for a second reading at a predetermined time differential;
an ignition interlock in the vehicle;
a microcontroller connected to and receiving data from the vapor sensor for comparison of the initial reading and the second reading, the microcontroller further connected to the ignition interlock and providing a signal to open the interlock to disable the vehicle upon a comparison of data from the vapor sensor exceeding a predetermined value.

2. The alcohol detection system as defined in claim 1 further comprising an identity verification system for an operator touching the touch sensor.

3. The alcohol detection system as defined in claim 2 wherein the identity verification system employs a fingerprint reader, said fingerprint reader connected to and providing data to the microcontroller.

4. The alcohol detection system as defined in claim 2 wherein the identity verification system includes a camera providing image data to the microcontroller.

5. The alcohol detection system as defined in claim 2 wherein the identity verification system includes an operator detector.

6. The alcohol detection system as defined in claim 1 further comprising a data logger connected to the microcontroller, said data logger receiving and storing data from the microcontroller including touch sensor data.

7. The alcohol detection system as defined in claim 1 further comprising a location system.

8. The alcohol detection system as defined in claim 7 wherein the location system comprises a GPS locator connected to and providing location data to the microcontroller.

9. The alcohol detection system as defined in claim 1 further comprising a GSM transmitter/receiver connected to the microcontroller, whereby the touch sensor data may be transmitted to a remote facility by the microcontroller.

10. The alcohol detection system as defined in claim 1 wherein the touch sensor is a tin oxide Taguchi type sensor and the predetermined time differential is 6 seconds.

11. The alcohol detection system as defined in claim 1 further comprising operator indicators.

12. The alcohol detection system as defined in claim 11 wherein the operator indicators include a first LED connected to the microcontroller and illuminating upon activation by the microcontroller at a predetermined time for initiating an alcohol test.

13. The alcohol detection system as defined in claim 12 wherein the operator indicators include a second LED connected to the microcontroller and illuminating upon commencement of an alcohol test and remaining illuminated for the predetermined time differential.

14. The alcohol detection system as defined in claim 13 wherein the operator indicators include a third LED connected to the microcontroller and illuminating upon a failed alcohol detection test.

15. An alcohol detection system for installation in a vehicle comprising:
a resistive touch sensor and a fingerprint reader mounted in a detector case in a vehicle, said touch sensor for determining presence of alcohol based on changed skin resistance and said fingerprint reader for verifying the identity of an operator touching the resistive touch sensor;
an ignition interlock in the vehicle;
a microcontroller connected to and receiving data from the touch sensor and the fingerprint reader, the microcontroller further connected to the ignition interlock and providing a signal to open the interlock to disable the vehicle upon receipt of data from the touch sensor exceeding a predetermined value;
operator indicators including a first LED connected to the microcontroller and illuminating upon activation by the microcontroller at a predetermined time for initiating an alcohol test, a second LED connected to the microcontroller and illuminating upon commencement of an alcohol test and remaining illuminated during a predetermined test period, and a third LED connected to the microcontroller and illuminating upon a failed alcohol detection test;
a location system incorporating a GPS locator connected to and providing location data to the microcontroller;
a data logger connected to the microcontroller, said data logger receiving and storing data from the microcontroller including touch sensor data, fingerprint reader data and location data; and,
a GSM transmitter/receiver connected to the microcontroller, whereby the touch sensor data, identity data and location data may be transmitted to a remote facility by the microcontroller.

16. A method for disabling a vehicle with an alcohol detection system including a resistive touch sensor comprising:
powering the system on;
recording a startup time on a data logger by a microcontroller;
activating an operator indicator to notify an operator that a test is required at a predetermined time programmed into the microcontroller;
reading vapor sensor data when the operator places a finger on a touch sensor;
activating a second operator indicator signifying that the test is in process;
activating the elements of an identity verification system and location and anti-theft system;
collecting data with the microcontroller from the vapor sensor at a predetermined time differential, identity verification system and a location and antitheft system;
if the operator removes his finger before testing is completed at the predetermined time interval, returning to the step of activating the operator indicator a requiring the operator to restart the test;
extinguishing the second operator indicator notifying the operator that the test is complete;
storing time/date information and data from the touch sensor, identity verification system and location and anti-theft system in a data logger;
if the test result shows impairment, notifying operator with a third operator indicator to show test failure;
opening the ignition interlock preventing operation of the vehicle; and,
if no impairment is shown by the test, remaining inactive for a predetermined period until additional testing is required.

17. The method of claim 16 further comprising:
transmitting data using a GSM transmitter/receiver with test result data, vehicle location and driver identification.

18. The method of claim 16 wherein the step of opening the ignition interlock further comprises illuminating a vehicle hazard flasher.

19. The method of claim 16 wherein the step of activating the elements of an identity verification system includes activating a fingerprint reader and activating a camera for photographic images of the operator.
